(19) United States
(12) Patent Application Publication
(10) Pub. No.: US 2003/0032461 A1
(43) Pub. Date: Feb. 13, 2003

(54) Earpiece for mobile electronic devices

(76) Inventor: John J. Desrosiers, Los Angeles, CA (US)

Correspondence Address: Mr. John Desrosiers, 11693 San Vicente #495, Los Angeles, CA, 90049, US

(21) Appl. No.: 10/213,659

(22) Filed: Aug. 6, 2002

Related U.S. Application Data
(60) Provisional application No. 60/310,639, filed on Aug. 7, 2001.

(51) Int. Cl. H04M 1/00; H04B 1/38

(52) U.S. Cl. 455/569; 455/575

(57) ABSTRACT

A system for attaching earpieces to portable or vehicular electronics is described, as is a procedure for using it. The system is unique in that it can be conveniently operated with one hand.

This application claims the benefit under 35 US 119(e) of U.S. provisional application No. 60/310,639 filed on Aug. 7, 2001.

### BACKGROUND OF THE INVENTION

This invention relates to earphones and microphones that are typically attached to mobile electronic devices that accept or emit sound. Particularly, this invention aims to make said earphones and microphones convenient and safe to store, access, put into the ear, use, and put away.

A there is a need among users of many types of mobile electronics to use those devices with earphones and/or an earphone and microphone combination, generally referred to herein as a headset or earpiece. Examples of such devices are mobile stereos, wireless telephones (for example, cellular phones and cordless phones), and so-called multi-function mobile devices.

Notably, recent safety and health concerns are motivating the use of headsets with wireless telephones, instead of holding the handset to one's ear. Unfortunately, headset use is often impractical due to the inconvenient and time-consuming nature of donning mobile headsets, especially when answering a telephone call. Consider the process of retrieving phone, retrieving headset, untangling headset cord, inserting headset into ear, plugging headset into telephone, and finally activating the telephone. Recently-proposed cordless headsets may eliminate some of the steps outlined above, but—cost aside—their use remains at best inconvenient and renews health concerns about placing a radio transmitter in the ear.

The present invention eliminates the inconvenience and wasted time of using a headset by cradling the headset and cord in or on the mobile device in such a way as to enable convenient operation in the modes described below. Further, donning or stowing the headset is typically one-handed, requires a single motion, and takes only one to two seconds. Note that the headsets under discussion are not only the type that encircle the head but also the type that fit in or onto the car, known as the “ear bud,” “ear loop,” “clip,” or types. Also note that some earpieces have a microphone boom attached to them, but several current headsets with microphones usually have the microphone integrated with the earpiece, or have the microphone mounted coaxially on the earpiece cord several inches from the earpiece (coaxial microphone type). Additionally, it is possible to configure a hybrid hand-held device with an earpiece without microphone; the optional microphone function can be separate, such as a microphone mounted on the mobile device housing.

A number of cord retractors are currently commercially available for use with cellular telephones. These devices are typically boxes which plug into the earpiece port of the telephone and are designed to be attached to the wearer's belt with a clip, or to hang loose. Current devices are too bulky for users to conveniently attach to telephones or earpieces. These devices are inconvenient because they are separate from the telephone, so the user must deal with two separate packages. Further one-handed operation of both the telephone and earpiece together is difficult unless the telephone or cord retractor are attached to the wearer's person or clothing.

Houlihan (U.S. Pat. No. 5,467,324) describes a wristwatch-mounted radiotelephone that has an integrated cord reatractor and earpiece that the user pulls from the wristwatch using his or her free hand. Unfortunately, Houlihan's design is only for wristwatches and thus inherently requires two hands to operate: the hand the watch is on, and the hand used to don the earpiece. Houlihan's invention also requires a miniature wristwatch-mounted radiotelephone, which is incompatible with current minituarization technologies. Also, Houlihan's invention requires a wrist strap, which is incompatible with consumers' current preference for handheld devices.

### SUMMARY OF THE INVENTION

A device and method of use are described for an arrangement which associates a mobile electronic device or vehicle-mounted electronics with an earpiece in such a way that the earpiece and its cord (if any) are conveniently stored, accessed, donned, and stowed. The device may include an earpiece receptacle or storage area in the mobile electronic device, and may also include a cord-retractor means mounted in or on the mobile electronic device, its cord, or earpiece.

### BRIEF DESCRIPTION OF THE DRAWINGS

FIG. 1 is an elavational view of a mobile electronic device incorporating the invention, with the earpiece stowed.

FIG. 2 is an elevational view of a mobile electronic device incorporating the invention, with the earpiece partially extended.

FIG. 3 is an elevational view of a mobile electronic device incorporating the invention, with the earpiece fully extended on its cord

FIG. 4 is a side elevational view of a person in the process of retracting the earpiece from a mobile electronic device, with the earpiece already in the ear.

FIG. 5 is an elevational view of a person's hand in the process of retracting the earpiece from a mobile electronic device.

FIG. 6 is an elevational view of a person's hand in the process of retracting the earpiece from a vehicle-mounted electronic device.

### DETAILED DESCRIPTION OF THE PREFERRED EMBODIMENTS

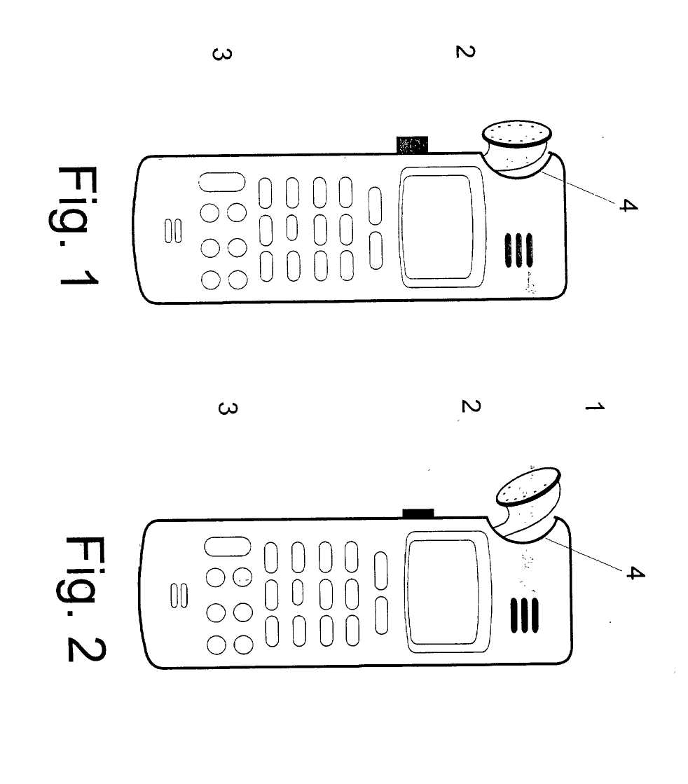

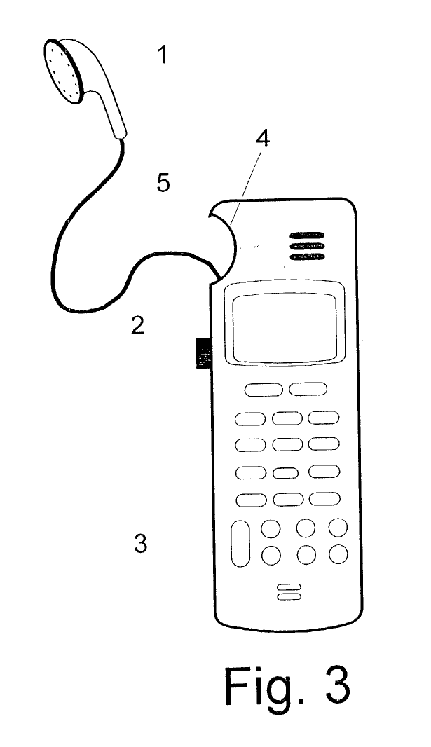

An illustrative embodiment of the invention is shown in FIGS. 1-6. As shown on these figures, an earpiece 1 is attached to a mobile electronic device 3 by a cord 5. Mobile electronic device 3 optionally provides a receptable 4 which securely holds the earpiece 1 while not in use. A control 2 is optionally provided to partially extend the earpiece 1 from the mobile electronic device 3 to aid the user 6 in accessing the earpiece 1. In particular, FIG. 1 shows the earpiece 1 fully stowed in the mobile electronic device 3. FIG. 2 shows the earpiece 1 partially extended from the mobile electronic device 3 in response to activation of control 2. FIG. 3 shows the earpiece 1 and cord 5 fully retracted from the mobile electronic device 3.

For illustration purposes, FIGS. 1-6 show an earpiece 1 that consists of an “in-ear” style earphone integrated in the same housing as a microphone with a “stubby” microphone boom, attached to a cord 5. As is well known in the art, there are also multiple other styles of earphones, microphones and earphones combined with microphones—referred to herein as earpieces—which can be used with this invention. Likewise, an earpiece 1 may or may not be attached by a cord 5 to a associated mobile electronic device 3—it may be cordless. This invention may be embodied using any style of earpiece 1 that is compatible with the associated mobile device 3.

Likewise, FIGS. 1-6 show a mobile electronic device 3 which happens to be a cellular telephone for illustrative purposes, but this invention may be embodied in any mobile electronic device which accepts, emits, or accepts sound, or signals representing sound waves or sound wave analogs. Such devices include, but are not limited to, cordless telephones, pagers, mobile digital assistants, mobile stereos, mobile computers, MP3 players, mobile radios, “walkie-talkies,” mobile voice recorders, mobile voice players, mobile electronic games, mobile video players, mobile televisions, mobile navigation or orientation systems, voice-recognition systems, voice synthesizers, communication gear.

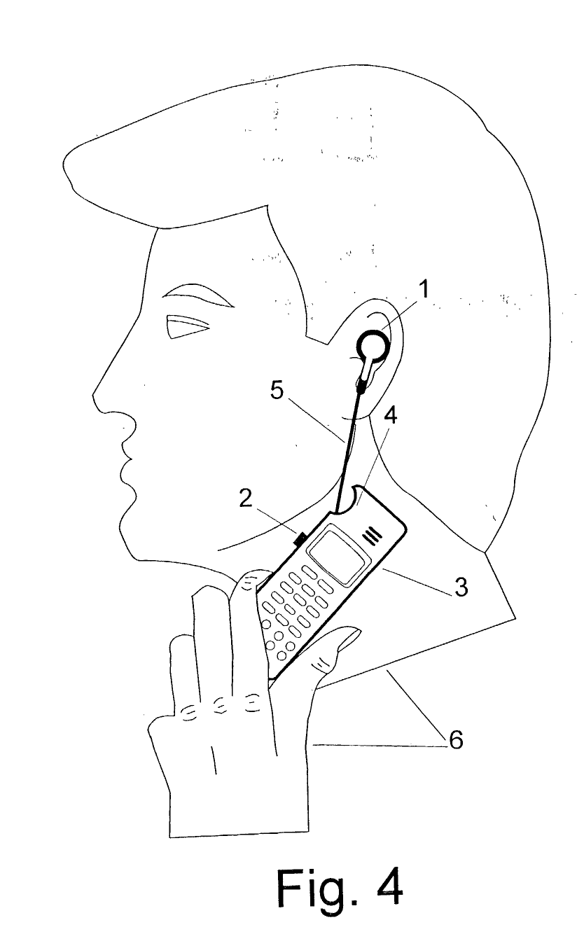

FIG. 4 illustrates so-called hand-held usage mode. It shows a user 6 holding the mobile electronic device 3 in hand, and extending the cord 5 by tugging on the mobile electronic device 3 away from the earpiece 1 which is held to the user's ear area by mechanical means.

In hand-held usage mode, the user 6 holds the mobile electronic device 3 in one or both hands. The earpiece 1 is mounted such that the user 6 can don the earpiece 1 by bringing the device 3 to his ear, hook the mobile device's 3 protruding earpiece 1 into, over or onto the ear, then pull the mobile device 3 away from the ear to operate its controls while the earpiece 1 remains in the user's ear. Above-mentioned set of actions can typically be executed in one convenient motion. A corded earpiece 1 will typically—but not necessarily—have a cord-retractor means mounted on or in the device, the earpiece 1, or coaxially on the cord 5 itself. Stowing of the earpiece 1 can be accomplished by bringing the mobile device 3 to the earpiece 1, docking the earpiece 1 to the device, and bringing the assembly away from the ear.

If a cord retractor means is present, it may be constructed to provide constant tension on the cord 5, to provide tension only while retracting the cord 5, or to provide tension only at certain times or for certain ranges of cord extension. If a cord retractor is present, the it may be activated to retract the cord 5 by a control located in or on the mobile device 3, cord 5, earpiece 1 or other attachment, or may be activated by tugging on the cord if the retractor is the roller-blind (jerk to release) type, or by other command or control means. Such means include, but are not limited to: voice commands, buttons, cranks, and switches. In the case where the earpiece 1 is cordless, the mobile electronic device 3 typically—but not necessarily—includes a receptacle which securely holds the earpiece 1 while not in use. Stowing the earphone can typically be completed in one convenient motion using this invention.

Further, the extended or retracted status of the earpiece 1—or the process of extending and retracting the earpiece 1—can optionally serve as a control to the associated mobile electronic device 3. For example, a switch means can be mounted in the earpiece-stowage cavity of the mobile electronic device 3 or associated with the cord-retractor means. Such a control could be used, for example, to energize and dis-energize the associated device 3. Another example of such a control's usage could be to put a mobile telephone into “talk” mode when it is ringing and earpiece 1 is un-stowed. These examples are by no means exhaustive.

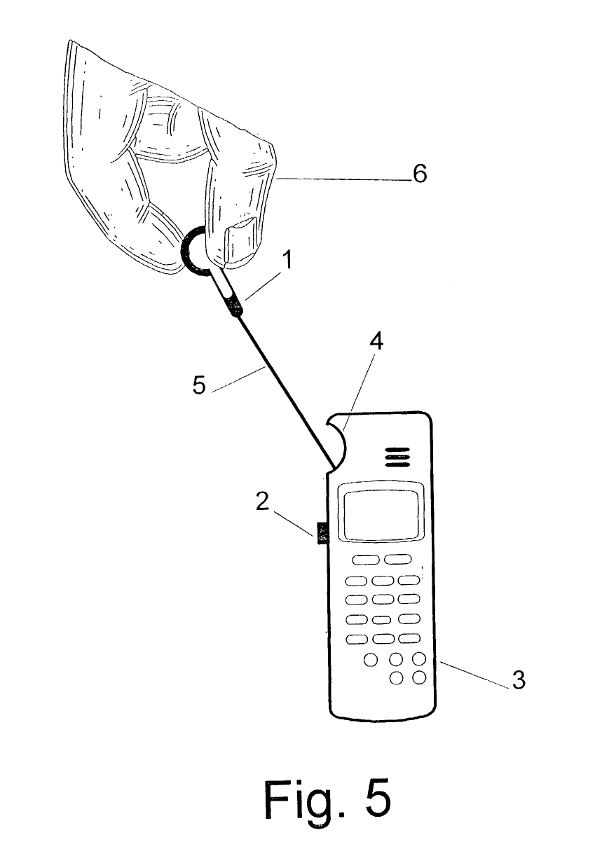

FIG. 5 illustrates so-called fixed usage mode. It shows the hand of a user 6 extending the cord 5 by holding the earpiece 1 and pulling it away from the mobile electronic device 3. In this fixed-usage mode, the mobile electronic device 3 may be held by the user 6, may be attached to another object, or may be free-standing.

In this fixed usage mode, the device 3 is stationary, for example on a table, in a pocket, or attached to the user's belt. The user simply grasps the earpiece 1 mounted to the device 3 and brings it to her ear, then hooks the earpiece 1 into, onto or over the ear. Above-mentioned set of actions can typically be executed in one convenient motion. The earpiece 1 can be corded or cordless. The device 3 may be activated using a control on or in the earpiece 1, cord 5 or device 3. A corded earpiece 1 will typically—but not necessarily—have a cord-retractor means mounted on or in the device, the earpiece 1, or coaxially on the cord 5 itself. Stowing of the earpiece 1 can be accomplished by unhooking the earpiece 1 from the ear and docking the earpiece 1 to the mobile device 3, again typically in one convenient motion. Operation of a cord retractor is most convenient if retraction is activated by a roller-blind-type mechanism, by a control on the earpiece 1, by a control on the device 3, or voice command, or by other events in the mobile electronic device 3, for example a telephone call ending. If a cord retractor means is present, it may be constructed to provide constant tension on the cord 5, to provide tension only while retracting the cord 5, or to provide tension only at certain times or for certain ranges of cord extension.

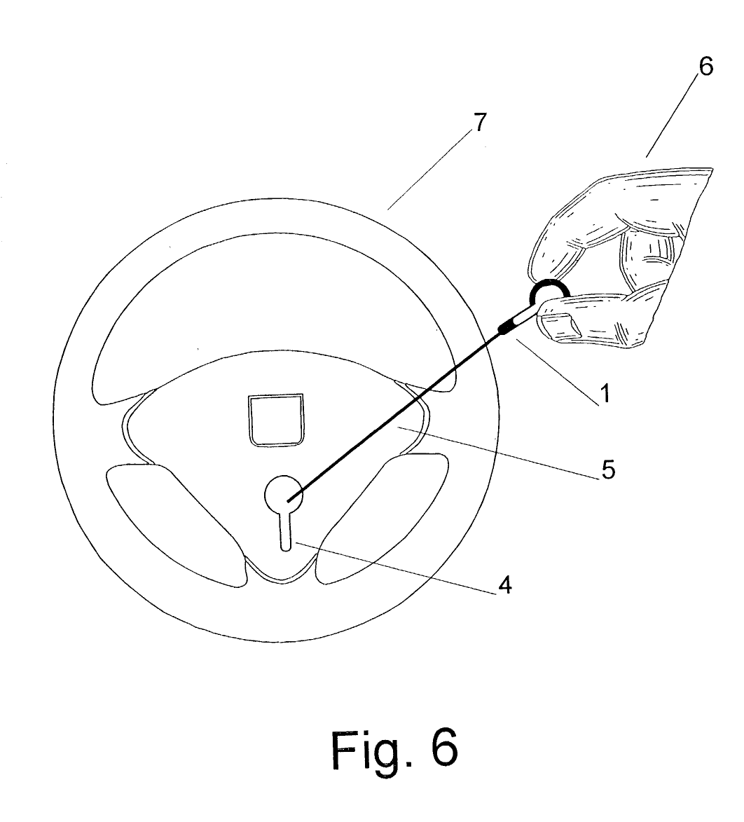

FIG. 6 illustrates a variation of fixed usage mode where the earpiece 1 is tethered or associated with a vehicle. It shows the hand of user 6 extending the cord 5 by holding the earpiece 1 and pulling it away from the receptable 4 built into portion 7 of a vehicle. One or a plurality of electronic devices are also located in the vehicle, and accept or emit sound via the earpiece 1. Vehicle portion 7 is illustrated as a steering wheel, but can be any place conveniently accessible to the occupant of any vehicle, such as the dashboard, door, seatback, armrests, ceiling, or other convenient place in the vehicle. The earpiece may be connect with vehicle-mounted electronics, or may terminate in a releasable connector, port or wireless transceiver which a user may connect or associate with removable electronics. For example, the earpiece 1 may be tethered to a vehicle portion 7, which in turn is connected via in-dashboard wiring to a wireless transceiver mounted in the dashboard of an automobile; the wireless transceiver transceives sound to and from a cellular telephone in the pocket of a user 6 in the automobile. In the case where the earpiece 1 is cordless, the vehicle portion 7 typically—but not necessarily—includes a receptacle that securely holds the earpiece 1 while not in use.

In this fixed usage mode, the user 6 simply grasps the earpiece 1 mounted to the vehicle portion 7 and brings it to her ear, then hooks the earpiece 1 into, onto or over the ear. Above-mentioned set of actions can typically be executed in one convenient motion. The earpiece 1 can be corded or cordless. The vehicle-mounted electronic device may be activated using a control on or in the earpiece 1, cord 5 or on the vehicle. Again, a corded earpiece 1 will typically—but not necessarily—have a cord-retractor arrangement associated with it If a cord retractor means is present, it may be constructed to provide constant tension on the cord 5, to provide tension only while retracting the cord 5, or to provide tension only at certain times or for certain ranges of cord extension. Stowing of the earpiece 1 may be accomplished by unhooking the earpiece 1 from the ear and docking the earpiece 1 to the vehicle portion 7, again typically in one convenient motion. Operation of a cord retractor is most convenient if retraction is activated by a roller-blind-type mechanism, by a control on the earpiece 1, by a control on the vehicle, or voice command, or by other events associated with the associated mobile electronic device, for example a telephone call ending.

Again, in fixed-usage mode the extended or retracted status of the earpiece 1—or the process of extending and retracting the earpiece 1—can optionally serve as a control to the associated mobile electronic device 3 or vehicular electronic device.

Considerations for Two-ear (stereo) usage: Many mobile devices 3, notably mobile stereos, require the user to wear one earpiece in each ear. There are two types of stereo earpieces 1, each used differently with this invention. In both cases, the cord or cords may have a cord retractor means

The earpieces 1 in question are typically mounted on one main cord 5, with the two earpieces 1 branching out from the main cord 5. The above usage modes easily accommodate those stereo earpieces 1 with the following modifications to the donning and storing procedures: in both cases, the first earpiece 1 is donned, leaving the second earpiece 1 effectively dangling from the first on a short length of cord. The second earpiece 1 may be conveniently attached to its respective ear at the user's 6 leisure. The removal procedure requires the user 6 to remove one earpiece 1 before performing the procedures outlined above, or optionally after removing the first earpiece 1 in the hand-held usage mode.

Some stereo earpieces 1 consist of two separate earpiece 1 and cord 5 assemblies, or are cordless. In such an arrangement, operation in both usage modes may be repeated twice as outlined above, once for each ear. Note that hybrid arrangements are possible—for example for a combination telephone and stereo device—where one earpiece 1 is used per “Hand-held usage mode,” or “Fixed usage mode,” above, while the other earpiece 1 is used otherwise.

It will be readily appreciated by those skilled in the art that this invention's functionality need not originally be built into an earpiece 1, a mobile electronic 3 device, cord 5, or vehicle. The functionality can be build as a retro-fit kit or accessory. For example, a thin cord-retractor and earpiece 1 can be designed to attach to a surface of a mobile electronic device 3 and to connect to the mobile electronic device's 3 earphone jack. Further, such a cord-retractor could particularly attractively packaged by building it into another accessory which itself attaches to a mobile electronic device 3. An example of such an accessory would be a cellular telephone battery with a built-in cord retractor and earpiece. Similarly, a cradle to conveniently hold a cordless earpiece 1 as disclosed herein may be designed to be attached to a mobile electronic device 3.

It will also be readily appreciated by those skilled in the art that this invention may be delivered or sold as separate parts, and that the sum of the parts will provide the functionality described herein. For example, a simple vehicle-mounted cradle designed to hold a cordless earpiece 1 associated with a mobile electronic device 3 enables said device and earpiece combination to be used according to this invention.

It will also be readily appreciated a less-convenient variation on this invention can be constructed for some applications wherein a cord retractor is built in or attached to the earpiece 1 as above, but where the “free” end of the cord 5 is terminated with a releasable connector which can be connected to compatible equipment. Such an earpiece 1 and cord retractor arrangement provides convenient storage of the earpiece's 1 cord 5.

I claim:

1 A portable hand-held device which comprises:
hand-held generator apparatus for generating electrical representations of sounds;
sound transducer means which convert said electrical representations into sound waves and which can be deployed from said hand-held generator apparatus into proximity with at least one of user's ears;
cord means attaching said sound transducer to said hand-held generator apparatus;
cord-storage means mounted to said hand-held apparatus;
cord-retractor means mounted to said hand-held generator apparatus which can substantially dispense said cord means from said cord-storage means and which can substantially retract said cord means into cord-storage means.

2 The portable hand-held device of claim 1 in which said cord-retractor and cord-storage means are removably mounted to said hand-held generator apparatus.

3 The portable hand-held device of claim 1 in which said cord-retractor and cord-storage means are built in to the hand-held generator apparatus

4 The portable hand-held device of claim 1 in which includes means to removably mount said sound transducer to said hand-held apparatus.

5 The portable hand-held device of claim 1 in which said hand-held generator apparatus includes wireless telephone means.

6 The portable hand-held device of claim 4 in which said hand-held generator apparatus includes wireless telephone means

7 The portable hand-held device of claim 1 in which said cord-retractor means uses stored energy to retract said cord means into cord-storage means.

8 The portable hand-held device of claim 8 in which further comprises control means to enable a user to control when the cord-retractor means retracts said cord means.

9 The portable hand-held device of claim 1 which further comprises sensor means which control specific functionality of said hand-held device depending on whether said cord-retractor means is retracted or extended

10 A device which comprises:
a motorized vehicle;
one or more vehicle-mounted generators apparatus for generating electrical representations of sounds;
sound transducer means which convert said electrical representations into sound waves and which can be deployed from said vehicle into proximity with at least one of user's ears;
cord means attaching said sound transducer to said vehicle;
cord-storage means mounted to said vehicle;
cord-retractor means mounted to said vehicle which can substantially dispense said cord means from said cord-storage means and which can substantially retract said cord means into cord-storage means into cord-storage means

11 The device of claim 10 which further comprises storage attached to said vehicle for said sound transducer means.

12 The device of claim 10 in which said vehicle-mounted generator apparatus includes wireless telephone means.

13 The device of claim 11 in which said vehicle-mounted generator apparatus includes wireless telephone means.

14 The device of claim 10 in which said cord-retractor means uses stored energy to retract said cord means into cord-storage means

15 The device claim 14 in which further comprises control means to enable a user to control when the cord-retractor means retracts said cord means.

16 The device of claim 10 which further comprises sensor means which control specific functionality of said device depending on whether said cord-retractor means is retracted or extended.
